(19) United States
(12) Patent Application Publication
(10) Pub. No.: US 2012/0081707 A1
(43) Pub. Date: Apr. 5, 2012

(54) SHEAR FLOW DEVICE AND METHODS OF USE

(76) Inventor: Bengt Norden, Vastra Frolunda (SE)

(21) Appl. No.: 13/175,017

(22) Filed: Jul. 1, 2011

Related U.S. Application Data
(60) Provisional application No. 61/361,165, filed on Jul. 2, 2010.

(51) Int. Cl. G01J 4/00; G01N 21/01

(52) U.S. Cl. 356/364; 356/244

(57) ABSTRACT

The present invention relates to shear flow device 100 comprising cell 110, wherein the cell is static and comprises stationary plates 110a and 110b, and movable slide 130. The device of the present invention can be used in methods of orienting molecules for LD measurement and in methods for creating an oriented macromolecule or macromolecule complex.

### RELATED APPLICATIONS

This application claims the benefit of U.S. Provisional Application No. 61/361,165, filed Jul. 2, 2010, the entire contents of which are incorporated herein by reference.

### BACKGROUND OF THE INVENTION

Understanding the processes involved in molecules interacting with DNA-molecules, membranes and fibers is essential in many applications such as drug delivery or protein functionality. The orientation of these molecules in the larger structure, such as a molecule or protein in a lipid membrane or DNA, can give information regarding the nature of this interaction. There are few techniques that enable the direct measurement of these properties. Linear Dichroism (LD), however, is a technique in which the anisotropic absorption of a sample can be studied. Absorption anisotropy (so called LD) has been measured on oriented samples, for example, biological macromolecules, for more than 50 years. It is defined as the differential absorption of plane polarized light by an ordered sample. If the degree of orientation of a sample relative to an external coordinate system is known, then the angle between a transition moment of an absorbing species and the oriented structure can be determined. This technique has been shown to be very useful in the study of transition moments in chromophores as well as in the orientation of membrane active peptides.

In order to measure LD of a sample molecule it is necessary to create some degree of macroscopic orientation in the system. Despite these promises of LD, the devices used for making the molecular samples partially oriented are considerably complicated. The devices typically consist of two concentric quartz cylinders, one solid in the centre, which is static, and one surrounding outer cylinder which is rapidly rotating—and the sample solution is fed into the annular gap between the cylinders. A probing light beam in a spectrometer is passing through the centre of the static and the rotating cylinders and the sample in between. The oriented molecules are probed by varying the polarization of light being parallel and perpendicular to the flow lines. (The LD is defined as the absorption parallel minus the absorption perpendicular.) In an alternative flow cell the sample is pumped by an external pump between parallel (static) quartz plates. Some of the most common techniques to do this have been by gel-compression, electrophoretic orientation or flow. The various techniques possess different advantages and disadvantages depending on the sample, but for aligning long DNA chains or different types of lipid membranes, the Couette-flow cell is the most efficient to date. However, this device requires large sample volumes and there is a higher cost associated with the large high quality pieces of quartz needed to construct such a cell. Smaller cells have been constructed that require less sample, but the cost still remains an issue and as the cylinder becomes smaller, alignment becomes problematic because of the refractance of light due to the sharp curvature of the cell.

Accordingly, there remains a need in the art for the design of a small volume flow-orientation device for the study of bio-macromolecules.

### SUMMARY OF THE INVENTION

Described herein is a design that offers a number of advantages in respect to sample volume, design simplicity and economy, as it is considerably easier to find quartz plates of sufficient quality. This makes it cheaper, easier to maintain and adaptable, as all parts can be replaced individually.

The design of the present invention is particularly advantageous because it allows sample volume to be reduced. For example, in preferred embodiments, the sample volume can be reduced, for example, to 300 μl or less, and the path length can also be varied if necessary, providing versatility to the measurements. The net orientation achieved is of the same order as the established techniques used at present.

As described hereinbelow, the present invention features a flow-orientation device for the study of bio-macromolecules.

In a first aspect, the invention provides shear flow device 100 comprising cell 110, wherein the cell is static and comprises stationary plates 110a and 110b; and a movable slide 130.

In another embodiment, slide 130 fits inside the cell.

In another further embodiment, plates 110a and 110b are separated by spacer 120.

In still another further preferred embodiment, the spacer is between 1 μm-5 mm.

According to still further embodiments, plates 110a and 110b are comprised of a material that is transparent to ultraviolet, visible or infared light.

In further preferred embodiments, the plates 110a and 110b are quartz.

In other aspects, the present invention also features shear flow device 100 comprising quartz cell 110, wherein the cell is static and comprises plates 110a and 110b; and movable quartz slide 130. In certain further embodiments, plates 110a and 110b are stationary plates.

In one embodiment, slide 130 is connected to lever 170, and wherein the lever is connected to motor 180 via eccentric wheel 190.

In another embodiment, quartz slide 130 is moved in an oscillating motion.

In another further preferred embodiment, an LD spectrum is recorded during oscillation and a baseline is recorded at rest.

In still another further preferred embodiment, an absorbance spectrum (A) of the sample is recorded at rest.

In other further preferred embodiments, the device is used for the orientation of molecules for Linear Dichroism (LD) measurement.

In another aspect, the present invention also features a method of orienting molecules for LD measurement comprising applying a liquid sample to the device, wherein the liquid sample is subject to an oscillating flow, thereby orienting the molecules for LD measurement.

In one embodiment, LD is measured according to Formula 1:

LD=A(parallel)−A(perpendicular) (Formula 1)

wherein A is the absorption of the oriented molecules parallel and perpendicular to flow lines.

In another embodiment, the liquid sample volume is between 0.2 nanoliter−1.0 ml.

In another embodiment, the method further comprises determining a quotient spectrum according to Formula 2

LD/A (Formula 2)

wherein the quotient spectrum provides information about DNA orientation or DNA structure.

In another aspect, the present invention features a method for creating an oriented macromolecule or macromolecule complex comprising applying a liquid sample comprising the macromolecule or test sample to the device described herein, wherein the liquid sample is subject to an oscillating flow.

In one embodiment, the macromolecule is selected from DNA, RNA or protein. For example, fibrous proteins, such as proteins involved in Alzheimer's disease, cytoskeletal protein or prion proteins, though not limiting to the present invention, can be can be applied to the present invention.

In another embodiment, the test sample comprises an agent.

In another further embodiment, the agent is a pharmaceutical or a small molecule therapeutic.

Other features and advantages of the invention will be apparent from the detailed description, and from the claims.

### BRIEF DESCRIPTION OF THE DRAWINGS

FIG. 1 is a photograph of the device 100. To the right: vertical black bar 200 attached to eccentric rotating disc 190 (electric motor 180 at the back). Top: horizontal black bar 116 with adjustable pivot point for tuning the amplitude of oscillation. To the left: vertical white bar 117 connecting the top horizontal bar and slide 130 in the middle of the photo dipping into the space between two quartz windows 110 and 110b held against Teflon spacer 140 by screws (black knobs) 195 a, b and c. Eccentric wheel 190 is shown to the right in the middle: a brass wheel partly covered by black vertical plastic link 200 connected eccentrically to it by a steel bolt.

FIG. 2a is a schematic diagram of device 100. The diagram shows the principle of mounting the three silica plates together: oscillating quartz slide 130 between stationary quartz plates 110a and 110b and U-shaped spacer 120. FIG. 2b is a sketch of the LD-cell according to a preferred embodiment of the invention. Light passes through the cell in the x-direction. Alignment of the sample is caused by the oscillation in the z-direction of central quartz slide 135. This quartz slide is fastened onto Teflon block 150 that is guided by metal rods 160a and 160b to keep the plate centered in the cell. The cell, where the sample is injected from the top opening, is made up from quartz plates 110a and 110b separated by Teflon spacer 140.

FIG. 3 is a graph that shows LD-absorption spectra of ct-DNA with f=4 Hz and 5 mm amplitude, demonstrating the unaltered spectra (solid) and baselined spectra (dotted) obtained with the design. The baseline (dashed) is relatively straight with a slight decline towards 185 nm which most likely is due to some absorption of the fused silica.

FIG. 4 is a graph that shows the effect of increasing the amplitude of the oscillation, thus increasing the average and maximum speed of the quartz plate. Dotted line shows spectrum taken with 3 mm amplitude. Solid line is the spectrum acquired at 5 mm amplitude.

FIG. 5 is a graph that shows the LD of a) retinoic acid and b) pyrene in LUVs. In retinoic acid, the strong positive band around 350 nm is expected because the transition moment (parallel with the long-axis of the molecule) becomes aligned perpendicular to the membrane surface. Retinoic acid is used as a probe of membrane orientation. The weaker negative band around 425 nm is probably due to dimer formation of the molecule, expected to align along the surface of, rather than pointing through the membrane. In pyrene, another useful membrane probe, the bands with opposite signs represent different transition moments of the molecule.

FIG. 6 is a graph that shows the LD spectrum of insulin amyloid fibrils stained with ThT. The ThT transition are seen as a negative peak at 445 nm, indicating that the dye is oriented parallel to the fibril axes.

FIG. 7 is a graph showing the LD and absorption spectra of ct-DNA, LD recorded with f=4 Hz and 5 mm slide amplitude, demonstrating the unaltered spectra and baseline spectra obtained with the design. The baseline is relatively straight with a slight decline towards 185 nm which most likely is due to some absorption of the fused silica.

FIG. 8 is a graph that shows the LD of a) pyrene and b) retinoic acid in liposomes. In Pyrene the bands with opposite signs represents different transition moments of the molecule, whereas in Retinoic acid, the negative band around 425 nm is expected to be due to dimer formation of the molecule, expected to align along the surface of, rather than through the membrane.

FIG. 9 is a graph that shows spectra of two successive measurements of the same sample demonstrating the repeatability of the measurements. The two spectra show almost a perfect overlap.

FIG. 10 shows two graphs (a and b). a) is a graph that shows the LD signal for water without shear (red; bottom), and water at an oscillation rate of 100 rpm (cyan; top). b) is a graph that shows 5 mg/ml calf thymus DNA without shear, background corrected. The non-zero LD comes from the induced alignment of the DNA during sample loading (actually from pushing the glass plate through the sample), and is decreasing over time. The time between the first and last curves here is about 40 minutes. BW 1 nm, Step 1 nm, 0.5 secs per point.

FIG. 11 shows two graphs (a and b). a) is a graph that shows for the same sample, Same sample, increasing oscillation rate from zero to 1000 rpm. At the lower frequencies, the pulsing of the signal is due to the shear rate oscillating sinusoidally. At the higher frequencies the sample may be cavitating or generally misbehaving, although this was not apparent from visual inspection after the experiment. BW 1 nm, Step 1 nm, 0.5 secs per point. b) is a graph that shows for the same sample, a kinetic experiment. 250 rpm oscillation was halted after about 15 seconds. Wavelength 260 nm, BW 1 nm.

### DETAILED DESCRIPTION OF THE INVENTION

The present invention is directed to a new design of a flow-orientation device for the study of bio-macromolecules, for example and including DNA and protein complexes, as well as aggregates such as amyloid fibrils and liposome membranes, using Linear Dichroism (LD) spectroscopy. The design of the present invention is particularly advantageous because it allows sample volume to be reduced.

In preferred aspects, the device of the present invention consists of a thin sword or slide of quartz dipping into a narrow well surrounded by two quartz windows, for example, three parallel quartz plates one of which—the one in the middle—is oscillating, that is moving up and down. In particular preferred embodiments, the device comprises one window and one oscillating sword. One of skill in the art can easily produce such a device with one window and one oscillating sword by removing the upper stationary quartz plate. The liquid sample, on both sides of the central sword, becomes subject to an oscillating flow, which provides comparable orientation as in a Couette flow cell.

The sample volume is only fraction of a mL, the orientation highly reproducible, the optical properties superior to any earlier flow cell alternative.

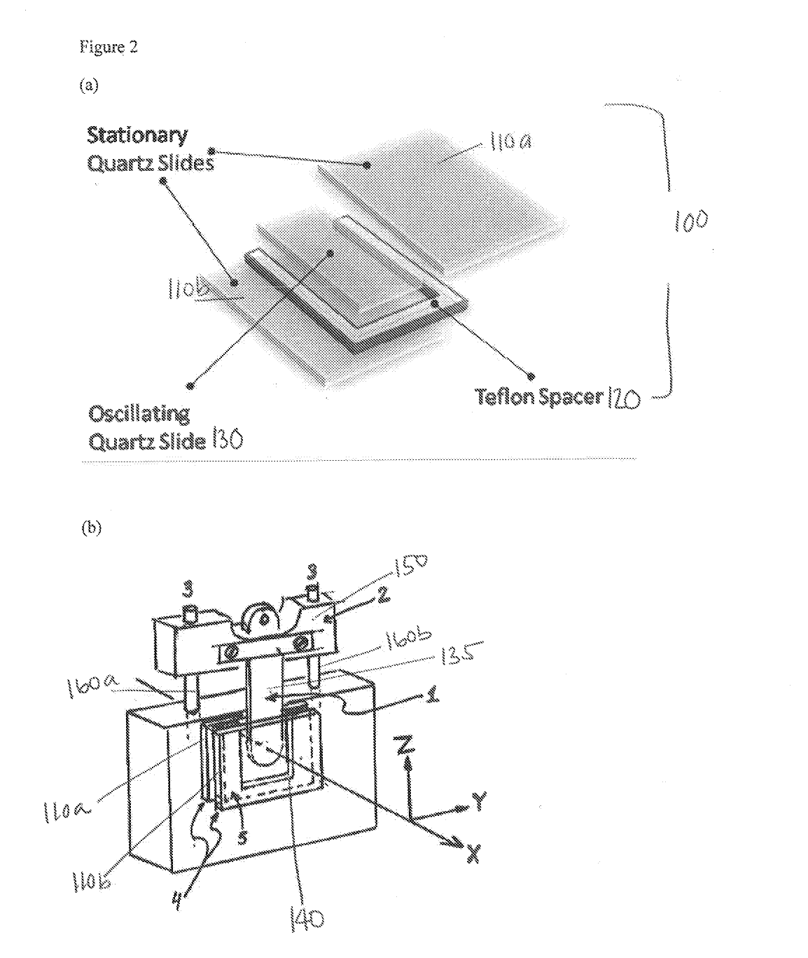

FIG. 2 illustrates device 100 of the present invention according to exemplary embodiments. FIG. 2 shows silica plates 110a, 110b and 130. Plates 110a and 110b are stationary quartz plates, and there is preferably oscillating quartz slide 130 with a front 132a and back face 132b, wherein the oscillating quartz slide is between stationary quartz slides 110a and 110b. U-shaped spacer 120, for example a Teflon spacer, is between stationary quartz plates 110a and 110b. In certain preferred exemplary embodiments, U-shaped spacer 120 is a Teflon spacer, however the spacer is not limited as such. According to other further preferred embodiments, the spacer comprises polyethylene, platinum, aluminum or other metal foils, depending on what solvents or sample thicknesses or volumes are desired.

The design of the present invention is particularly suited for use on small volumes of sample. In certain preferred embodiments, the sample volume is only fraction of a mL, preferably 500 μl or less, more preferably 300 μl or less.

Further, the design provides a number of technical advantages that make the device suitably inexpensive to manufacture, easier to use and more reliable than existing techniques. The degree of orientation achieved is of the same order of magnitude as that of the commonly used concentric cylinders Couette flow cell, however, since the device exploits a set of flat strain-free quartz plates, a number of problems associated with refraction and birefringence of light are suitably eliminated, increasing the sensitivity and accuracy of measurement. In certain preferred embodiments of the present invention, a considerable advantages of the design is the possibility to change parts and vary sample volume and pathlength easily and at a low cost.

The proposed device is inexpensive to manufacture (the cell might be treated almost as a laboratory consumable), has equal or better performance and is much more rapid to use compared to any earlier devices. The time to assemble, disassemble and clean the device is a few minutes, compared to hour with earlier devices. To run a spectrum takes only a few minutes. The study of oriented bio-molecules has, despite a great academic interest, remained a rather exotic field of science. The development of the new RNA field and the recently developed SDLD structure method, mentioned above, are anticipated to change the situation. However still, the methods used so far to produce oriented samples have severe disadvantages that have scared off many potential users. The electric field methods tend to rapidly degrade DNA samples (an exception is so-called electrophoretic orientation, a phenomenon discovered and published by the present inventor—but the equipment required is cumbersome to use). The pump-flow cells are simple from construction point of view but the external pump requires a relatively large additional sample volume and, furthermore, the shear gradient is not constant in the cell but high at the walls and falls off parabolically to zero in the center of the cell so the orientation is comparatively inefficient.

The cost of manufacturing a Couette orientation cell is high: during the past 15 years it has been between 10,000 and 30,000 dollars, depending on origin and workshop costs. The requirements on high optical quality of the fused-silica cylinders (they must be perfectly birefringence-free and transparent down to 180 nm) and their perfectly concentric geometry (better than 0.01 mm) have been main hurdles. In addition, their assembly and cleaning are as mentioned time-consuming. A limited life-time (accidents) provides an additional problem.

The simple orientation device proposed herein provides a similar shear rates to those of the Couette cell, but is superior in that the shear rate is constant across the gap. A sinusoidal motion makes G vary sinusoidally with time, being zero at the turning points and maximum in the middle, with change of sign every second stroke. Since the hydrodynamic orientation of DNA is apolar, the sign shift is unimportant, and an average orientation is observed parallel to the direction of oscillation. Frequency and stroke length can be varied depending on application, the simplest be typically 5 Hz and 10 mm as provided by a micro-motor with an excenter wheel. Using a piezo-electric crystal, and a lever to amplify the stroke amplitude, higher frequencies are in reach for other applications.

### DEFINITIONS

The instant invention provides, generally, a new design of a flow-orientation device for the study of bio-macromolecules, and methods of use.

The following definitions will be useful in understanding the instant invention.

As used herein, the term “comprising” is intended to mean that the compositions and methods include the recited elements, but do not exclude other elements. “Consisting essentially of”, when used to define compositions and methods, shall mean excluding other elements of any essential significance to the combination. Thus, a composition consisting essentially of the elements as defined herein would not exclude trace contaminants from the isolation and purification method and pharmaceutically acceptable carriers, such as phosphate buffered saline, preservatives, and the like. “Consisting of” shall mean excluding more than trace elements of other ingredients and substantial method steps for administering the compositions of this invention. Embodiments defined by each of these transition terms are within the scope of this invention.

As used in the specification and claims, the singular form “a,” “an” and “the” include plural references unless the context clearly dictates otherwise.

As used herein, the term “Linear Dichroism” (LD) refers to the differential absorption of plane polarized light. To measure LD the sample is oriented, then the difference in absorption of light linearly polarized parallel and perpendicular to the orientation axis is measured. In certain embodiments, LD is measured according to Formula (1): LD=A₍ₚₐᵣₐₗₗₑₗ₎−A_{(perpendicular)}, where A is the absorption of the oriented molecules parallel and perpendicular to flow lines.

As used herein, the term “sample” refers to an amount, for example an isolated amount, of a compound or composition. A typical sample comprises an amount of a composition or compound-of-interest, and may also contain one or more excipients, solvents, additives (e.g., stabilizers and antioxidants), or other compounds or materials. Exemplary samples are liquid samples with a volume between 0.2 nanoliter to 1.0 milliliter.

As used herein, the term “pharmaceutical” means any substance that has a therapeutic, disease preventive, diagnostic, or prophylactic effect when administered to an animal or a human. The term pharmaceutical includes prescription pharmaceuticals and over the counter pharmaceuticals. Pharmaceuticals suitable for use in the invention include all those known or to be developed. A pharmaceutical can be a large molecule (i.e., molecules having a molecular weight of greater than about 1000 g/mol), such as oligonucleotides, polynucleotides, oligonucleotide conjugates, polynucleotide conjugates, proteins, peptides, peptidomimetics, or polysaccharides or a small molecule (i.e., molecules having a molecular weight of less than about 1000 g/mol), such as hormones, steroids, nucleotides, nucleosides, or aminoacids.

### Device

A device is constructed for creating macroscopic orientation of DNA or other biological macromolecules or complexes between molecules or aggregates or fibers, or synthetic polymers, macromolecules or nanometer-size structures, based on hydrodynamic shear between one stationary and one moving, parallel plate.

In certain preferred embodiments, the plates are normally made of a material transparent to ultraviolet, visible and/or infrared light, as one major application be measurement of optical linear dichroism (=absorption anisotropy), as described herein.

The motion is oscillatory and along a line parallel to the planes of the plates, defining the preferred orientation direction. Various kinds of time-dependence (sine wave, saw-tooth, square pulse etc) and amplitude variations are claimed as they can improve orientation or, by their corresponding responses, provide additional information about the hydrodynamic characteristics of the sample molecules.

The orientation is caused by different velocities of the liquid at different distances from the wall of the plates. A molecule traversing flow lines that have different velocities will be subject to an orienting torque. In the ideal case the velocity difference, defined by the shear gradient G, is the same all over the bulk of the sample volume, but any application based on other flow profiles or properties, including turbulent ones, are claimed as well.

Preferably, the molecules to be oriented may be homogeneously dissolved in the solution between the plates.

Alternatively, the molecules to be oriented may be immobilized, by adsorption or by bonding or other means, to the surface(s) of the moving slide or the stationary one(s). The principle of their orientation is similar to the one above, i.e. caused by a velocity difference, but in this case it may be enough with a difference in velocity of liquid and surface, and optimal orientation may in fact be obtained by the correspondence of “plug flow”. All kinds of applications of shear-induced macroscopic orientations of surface-immobilized molecules, complexes, fibers, nanotubes and other nanometer-size structures are claimed.

In one embodiment, the device, as a prototype, consists of a slide of fused silica inserted into the cavity between two quartz plates separated by a spacer of approximately 1 mm. The cell is like a glass box, open at the top, with typical inner dimensions 30×40×1 mm. Optical measurements are made with light incident perpendicular to the largest surface of the box (10×40 mm), passing through the box at a pathlength of 1.2 mm. If the thickness of the inserted slide is 0.98 mm, the remaining volume of liquid sample will thus give a 0.11 mm thick layer on each side of the slide. When the slide is moved up and down (typically 5-10 mm) the motion will give rise to a shear-flow gradient (or shear rate) in the bulk volume of the liquid layer. At a velocity v of the slide, the shear-flow is defined by a flow gradient G=v/x where x is the size of the gap (in this case 0.1 mm). To obtain good alignment of DNA, suitable for most diagnostic purposes (see Background) a gradient of about 1000 s−1 is required, i e a velocity v=1000×0.1=100 mm/s. In the prototype device an average velocity of this size can be provided.

In another embodiment, the cell consists of an oscillating lever onto which a 0.98 mm thick quartz plate is fixed. An exemplary sketch of the LD cell is shown in FIG. 2b. The plate is guided to oscillate between the two quartz plates constituting the cell, at a fixed distance from the cell walls. The path length can be adjusted by varying the thickness of the Teflon spacers between the quartz plates. By varying the width of these spacers, it is also possible to adjust the sample volume required. To prevent the surface of the sample volume from oscillating excessively, a small trough has been made at the cell opening. In preferred embodiments, the cell is kept together by setscrews and can easily be dismantled, adjusted and cleaned. Preferably, the slide can be a rectangular central quartz slide, or a rounded quartz slide. The macroscopic orientation of the molecule is due to the oscillatory motion of the quartz plate. The speed of the plate is determined by the frequency and the amplitude (which is set by the length of the lever) of the oscillation. Preferably, measurements are carried out with f=5 Hz and the amplitude, A=5 mm. This gives an average velocity of 0.10 m s⁻¹ and a maximum velocity of 0.16 m s⁻¹. This can be translated into a shear gradient, G=v/x, with x as the gap between the wall and the oscillating plate, and v the velocity of said plate. G in this case becomes 1.455 m s⁻¹ at the maximum velocity and 0.910 m s⁻¹ on average. It is expected that a gradient of approximately 1 m s⁻¹ should be sufficient for most applications. From this equation it also follows that if a longer path length (larger gap) is desired, it is necessary to increase the velocity in order to obtain the necessary shear gradient.

The most commonly used cell is the Couette design, which consists of two concentric cylinders, one of which is rotating, with the sample contained in the annular gap. In this device the shear rate is not constant across the gap but decreases with increasing radius. Thus the sample towards the inner of the gap is subjected to a higher shear rate, G, and therefore presumably exhibits a greater degree of orientation, than that towards the outer of the gap. The narrow gap approximation G=2 ΠΩR/ΔR, where Ω is the angular speed in revolutions per second (rps), R is the radius of the outer cylinder and ΔR is the gap width, is often used to calculate the shear rate, although this is exact only in the limit as ΔR→0. In this approximation a rotational speed of 10 rps, with R=30 mm and ΔR=0.5 mm would give a shear rate of about 3800 s⁻¹. It is noted that problems due to deviations from the narrow gap approximation including centrifugal flow instability (so-called Taylor instability) tend to be worse in miniaturized Couette cells. By contrast, the device of the present invention is not prone to such problems and its performance can be expected to gain upon further miniaturization.

### Applications

The macroscopic orientation of DNA may be exploited as a diagnostic tool for detection of interaction of small molecules that become oriented when bound to the oriented macromolecule, but which are too small to become effectively oriented by themselves.

The macroscopic orientation may be quantitated using optical linear dichroism, i.e. LD=A(parallel)−A(perpendicular), i.e. the absorption anisotropy due to the anisotropic distribution of the transition moment(s) of a certain transition absorbing at a selected wavelength of light (in the ultraviolet, visible or infrared wavelength regions).

As shown by Nordén and others LD may provide valuable information about DNA binding geometries of drugs (e.g. cytostatic and/or antibiotic compounds) as well as of toxic compounds (e.g. carcinogenic and/or mutagenic compounds). For example, chemicals that do not display any LD (LD=0) generally do not interact with nucleic acids and are therefore generally not hazardous, whereas chemicals that display LD in presence of oriented DNA have been generally found to be mutagenic and/or carcinogenic. One important direct application is thus for a crude first screening of compounds for DNA interaction.

According to certain aspects, the present invention features a method of orienting molecules for LD measurement comprising applying a liquid sample to the device of claim 1, wherein the liquid sample is subject to an oscillating flow, thereby orienting the molecules for LD measurement.

In preferred embodiments, LD is measured according to Formula 1:

LD=A₍ₚₐᵣₐₗₗₑₗ₎−A_{(perpendicular)} (Formula 1)

wherein A is the absorption of the oriented molecules parallel and perpendicular to flow lines.

Preferably, the liquid sample volume is between 0.2 nanoliter−1.0 ml.

In other further embodiments, the method further comprises determining a quotient spectrum according to Formula 2

LD/A (Formula 2)

wherein the quotient spectrum provides information about DNA orientation or DNA structure.

Formula 2 may be derived at the assumption of a local uniaxial orientation distribution geometry. For a more general situation, measuring with light polarized parallel to the flow (stroke direction) yields A(parallel)=K<(cos 2Zz)> with Zz denoting the angle between flow direction, Z, and the light-absorbing transition moment direction, z, in the molecule, and K is a constant. Correspondingly, A(perpendicular)=K<(cos 2Yz)>, Y being the direction of polarization perpendicular to Z and the propagation direction of light; < > denotes ensemble average over the orientation distribution of the molecules in the light path. For the more general case one thus has: LD=K (<(cos 2Zz)>−<(cos 2Yz)>). For the isotropic sample one has approximately Aiso=K (<(cos 2Zz)>+<(cos 2Yz)>), showing how the parameter K, which depends on absorption intensity, concentration of sample and optical path-length vanishes in the ratio LD/Aᵢₛₒ

Accordingly,

LD/Aᵢₛₒ=(<(cos 2Zz)>−<(cos 2Yz)>,

thus being a function only of the orientation of the molecules. This is why this ratio is so useful for characterizing structural properties, whether DNA conformation, DNA-drug binding geometry or any other structural feature of the system that may be macroscopically aligned in the flow cell.

Another application, made possible by the fact that the device of the present invention can be used on very small sample volumes, is the study of specific interactions of synthetic or biologically produced DNA with well defined repeated sequence.

A changed orientation property due to some chemical, physical or hydrodynamic interaction—for example formation of antigen/antibody or other protein complex with different shape or size—may also be a principle useful for analytical applications. Impaired orientation as a result of elongated structures that aggregate into less easily orientable globular particles is known in several contexts (see e.g. Ref 4), for example, decreased LD from DNA has been used to assess binding of cationic peptides and dendrimers to DNA.

A recently reported application of LD called Site Selected Linear Dichroism (SSLD) for determining protein geometry (26). It is based on the principle of balancing the LD spectrum of a protein against a mutant in which a single aromatic amino-acid has been replaced by another aromatic residue with different absorption properties. The differential LD spectrum, in the simplest case when the substituent residue has negligible absorption, is then the LD of the replaced residue itself and may be used to determine the angular orientation of this residue relative to an external reference direction. A case where a number of residues of a DNA-protein complex were determined, in this way allowed the determination of the full three-dimensional structure of that complex. This application, which is more advanced, may thus be used for three-dimensional structure determinations in cases where techniques such as x-ray crystallography or nuclear magnetic resonance (NMR) cannot be applied.

Another application is the study of model membranes. The liposomes have normally on the average a spherical shape, but in a shear gradient they become distorted and preferentially oriented. By measuring LD one can study structure of peptides and proteins in the membrane lipid bilayer (23).

Another application is based on the probing of the DNA persistence length: if the structure of the DNA helix is changed, for example, due to bending or kinking upon binding of a protein, this will be sensitively reflected in an increased orientation decay rate upon switching off the orientation driving unit. Such an application has been demonstrated using electric-field induced DNA orientation, (24) and the device offers a simpler way to retrieve such data.

In other embodiments, applications include surfaced-immobilized DNA or other molecules who, or whose complexes, may become macroscopically oriented in the device. In addition to structural information provided by the measured LD, kinetic information may be obtained by monitoring LD and other properties as a function of time. In this way, for example, the binding geometries of a series of binding sites may be determined, as well as their binding rates, as they are sequentially populated by a certain ligand.

According to preferred embodiments, a main application of the invention, as designed for the prototype, is to produce efficient and stable macroscopic orientation of DNA for bio-analytical purposes. These include detecting interactions with drug candidates as well as potentially carcinogenic or else toxic substances, and to characterize their binding geometries. LD may provide information about the average angle between the drug (or rather its transition moment) and the DNA orientation axis: such information has been related to binding geometry and toxicity—for example, among carcinogenic metabolites of benzopyrene, only the one with positive LD (more parallel to DNA axis) has been shown to be the lethal one. Similar correlations have been made for a few other carcinogens.

A particularly interesting method is one that exploits repetitive DNA (with a given sequence repeating over and over again) so that interactions of a ligand with a specific DNA sequence can be studied.

Another application, as mentioned, is to determine three-dimensional structures of proteins that are systematically mutated to expose certain amino-acids—the Site Specific Linear Dichroism, SSLD method, demonstrated on the fibrous complex between DNA and RecA protein from E coli.2 More recently it has been demonstrated that SSLD can give information from which a 3 D structure of a protein complex may be determined (27). In one blow this has increased the interest in flow LD spectroscopy enormously since it could be applied to biological systems that are not amenable to traditional structure-biological study, including NMR and X-ray crystallography.

In other further exemplary embodiments, applications, with even more specific interactions of DNA or other bio-molecules, include the immobilization of one end of the biopolymer (or the ligand) to the silica slide. In the flow the molecule will become oriented, like seaweed on the bottom of a river. The orientation efficacy is predicted to be higher than with free-tumbling DNA and, consequently, shorter fragments may be oriented and studied. This application will involve the systematic variation of ligands and bulk solution so that the ligands may be studied with respect to binding rate and binding geometry simultaneously. The application to study binding rate (and dissociation upon washing with ligand-free buffer) is similar to that of Biacore. The extra dimension of directly observing binding geometry, could enable successive binding of ligands to their different targets and corresponding kinetics. All evidence indicates that complexity and sequential interaction steps is the rule rather than the exception.

The following Examples provide additional detail on the various embodiments of the device of the present invention, as well as examples of the use of these embodiments of the device of the present invention in exemplary methods of the invention for measuring linear dichroism.

### EXAMPLES

### Example 1

### Design of the Orientating Device

### Prototype and Test Experiments

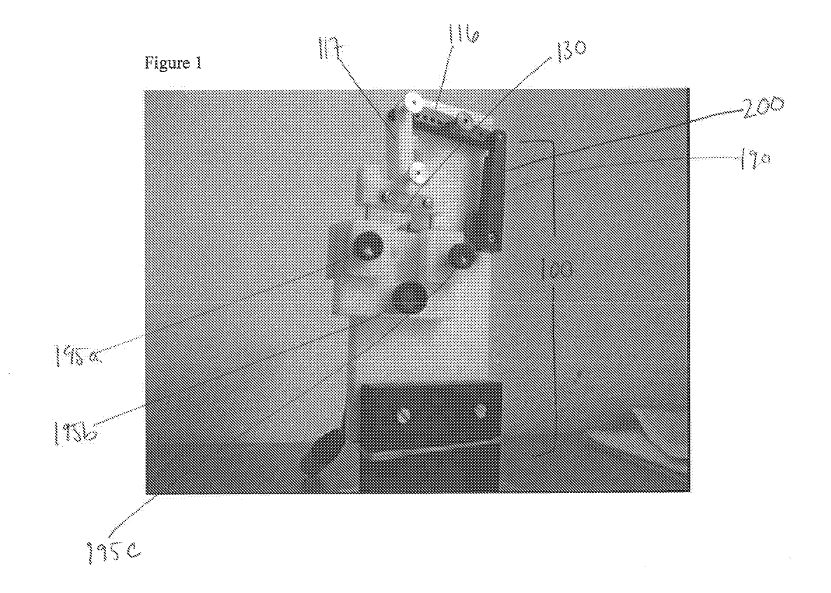

A machine drawing of the prototype device is shown in FIG. 1. The device is made of fused silica and consists of one static part, the cell, and one moving part, the slide, which has dimensions to fit snugly inside the cell. The slide is connected to a lever that is connected to a micro motor via an eccentric wheel. The motor causes the slide to oscillate in a sinusoidal motion at typically 4-10 Hz and with amplitude adjustable between 1 and 5 mm. The sample, 0.4 ml of a solution of calf thymus DNA, was placed inside the UV cell, the slide introduced so that sample liquid raised above the horizontal light beam of an LD spectrophotometer. An LD spectrum is recorded during oscillation and a baseline recorded at rest. Also, an absorbance spectrum (A) of the isotropic sample is recorded at rest. The quotient spectrum LD/A provides the desired information about DNA orientation and structure (and in case of bound ligand, binding geometry) as described elsewhere (25).

### Proof of Function

The LD is negative as expected for DNA, with LD=A(parallel)−A(perpendicular), parallel defined as the stroke direction of the device. The LD amplitude varies at a pace of 5 Hz. When recording the LD spectrum in the region 180-200 nm, which could be done with high accuracy within a minute showing the strength of the signal-to-noise, the shape was found identical to that of the LD spectrum of DNA known from traditional Couette flow cell experiments. The degree of orientation was typically 0.01, i.e. of the same order of magnitude as obtained with the traditional Couette device. When repeating the spectrum after some minutes the reproducibility was perfect (better than ca 3%).

Together these observations clearly demonstrate that the device manages to produce an excellent flow-orientation of DNA. The degree of orientation suggests that the flow profile is laminar and that the gradient be constant throughout the bulk of the sample solution. Reproducibility is found excellent and judged sufficient for most applications of previous, traditional devices.

The cell used in the experiments described herein consists of an oscillating lever onto which a 0.98 mm thick quartz plate is fixed. The plate is guided to oscillate between the two quartz plates constituting the cell, at a fixed distance from the cell walls. The path length can be adjusted by varying the thickness of the spacers between the quartz plates. By varying the width of these spacers, it is also possible to adjust the sample volume required. To prevent the surface of the sample volume from oscillating excessively, a small trough has been made at the cell opening. The cell is kept together by set screws and can easily be dismantled, adjusted and cleaned.

The macroscopic orientation of the molecule is due to the oscillatory motion of the quartz plate. The speed of the plate is determined by the frequency and the amplitude (which is set by the length of the lever) of the oscillation. Most measurements in this article are carried out with f=5 Hz and A=5 mm. This gives an average velocity of 0.10 m/s and a maximum velocity of 0.16 m/s. This can be translated in to a shear gradient, G=v/x, with x as the gap between the wall and the oscillating plate, and v the velocity of said plate. G in this case becomes 1455 s⁻¹ at the maximum velocity and 910 s⁻¹ on average. It is expected that a shear rate of approximately 1000 s⁻¹ should be sufficient for most applications. From this equation it also follows that if a longer pathlength (larger gap) is desired, it is necessary to increase the velocity in order to obtain the necessary shear gradient.

LD spectra were taken with a Chirascan fitted with an LD.3 Linear Dichroism detector. Collection parameters were 0.5 s/point, 1 nm step size, 1 nm bandwidth and all measurements were carried out at room temperature.

Absorption measurements were carried out in a Varian Cary 50 Bio UV-Vis spectrophotometer.

### Example 2

### Calf-Thymus DNA

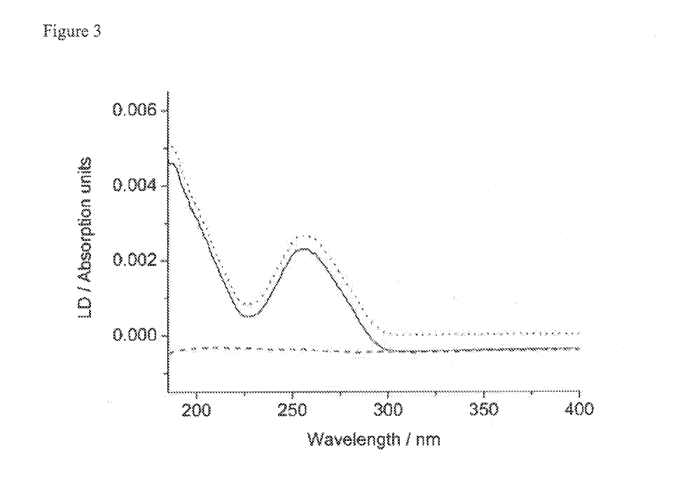

The LD spectra of DNA has been previously examined 1 (18-20). The absorption spectrum is dominated by the Π-Π* transitions of the purine and pyrimidine bases with a peak at 259 nm. In FIG. 3 the raw spectra, baseline and baseline corrected spectra of the ct-DNA is shown. The baseline (dashed) is very straight with only a slight decline towards 185 nm which most likely is due to some absorption of the fused silica. With most Couette devices an uncomfortably intense background LD provides baselines that vary strongly with wavelength, as a consequence of long optical pathlengths through quartz details and with quartz that due to curvature etc may have intrinsic birefringence (due to tensions in the material) which changes the polarization of the light. The LD-absorption spectra is positive since the DNA is oriented vertically in the design. Because the baseline is almost entirely flat, the baseline correction becomes mostly a matter of “zeroing” the spectra.

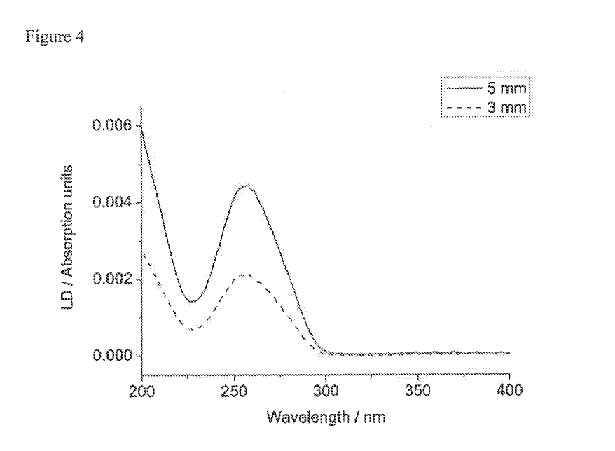

FIG. 4 demonstrates the effect of increasing the oscillatory speed on the orientation of the DNA. The base pairs are thought to be oriented at approximately 86° angle to the backbone (4). The measurements were carried out at 5 Hz. For the long lever the oscillatory amplitude was 5 mm and the average speed of the plate 0.10 m/s and for the short lever the amplitude was 3 mm and the average speed was 0.06 m/s. In order to determine the degree of orientation achieved, the orientation factor S is calculated. S is a scalar that can vary between 0 and 1, where 1 answers to a perfectly oriented sample and 0 means that the sample is entirely isotropic. This property can be calculated from equation (1) shown below:

$${LD}^{r} = \frac{LD}{{A}_{iso}} = \frac{3}{2} S ( 3 {cos}^{2} α - 1 ) \qquad ( 1 )$$

where LD^{r} is the reduced LD, Aᵢₛₒ is the isotropic absorption and α is the average angle between the transition moment and the DNA backbone. With A_{259 nm}=0.030 this gives an orientation factor, S, of 0.049 at 0.10 m/s and 0.023 at 0.06 m/s. This was compared to a standard Couette cell using the same sample solution. The S-value was calculated to be 0.094, i.e. approximately twice what was achieved in the new device. Some loss in orientation is expected due to the fact that data are collected over the entire oscillation, i.e. also at the endpoints, where the sample is expected to be more or less isotropic. If collection is synchronized to exclude these endpoints, the average S achieved is expected to increase significantly. However, the orientation achieved under the conditions used here is sufficient for most applications.

### Example 3

### Large Unilamellar Vesicles (LUVs)

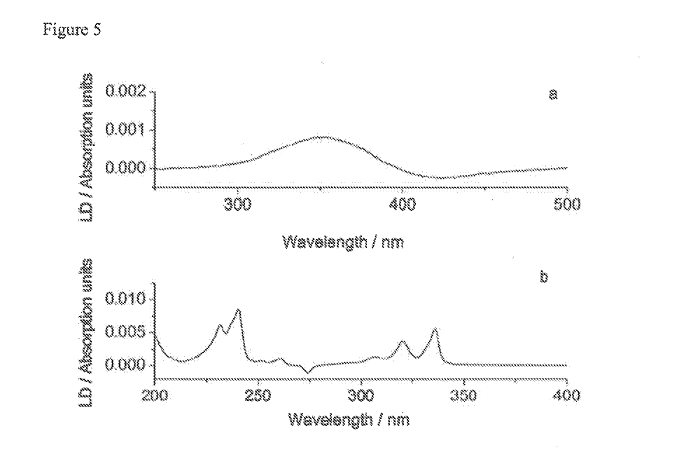

The resulting LD-absorption spectra from pyrene and retinoic acid in LUVs is shown in FIG. 5. In pyrene the two orthogonal transition moments can be seen, with the negative peak at 274 nm as an indication of the Syy orientation, and the positive bands as the orientation in Szz. The negative band in the retinoic acid spectrum at approximately 425 nm on the other hand is thought to be a result of retinoic acid forming dimers and aligning along the surface of the membrane. This would explain the negative sign, and the absorption of such dimers would be expected to be red shifted compared to the single molecule. The LDr for retinoic acid is 0.011 which is approximately 20-25% of what has been achieved in previous studies using a Couette flow cell (6).

### Example 4

### Amyloid Fibrils

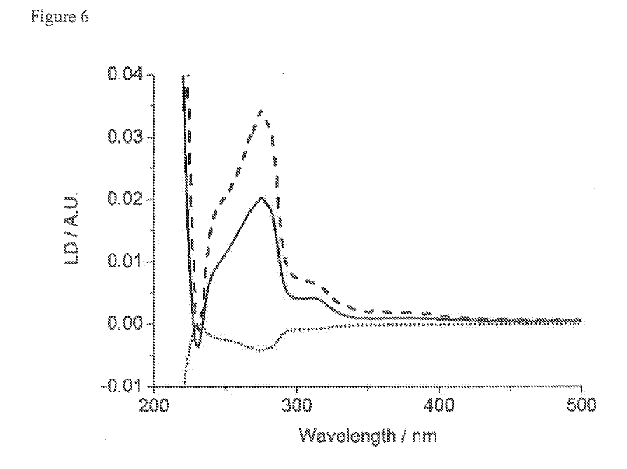

The resulting LD spectrum of insulin amyloid fibrils stained with ThT is shown in FIG. 6. The spectrum shows a negative peak at 445 nm, which corresponds to the ThT dye being oriented parallel to the fibril axis(21-22). The peaks at 276 nm and 230 nm are due to the two orthongal transitions of Tyrosine. Finally, the dominating 195 nm peaks are due to the orientation of the beta-sheets in the amyloid fibrils. There is a slope in the spectra that is apparent in the magnified inset. This is due to elastic scattering of the fibrils and increases towards shorter wavelengths.

As described herein, a new design for the orientation of long molecules and liposomes is described. The design shows very good orientation ability for all tested samples and possesses a number of advantages compared to existing designs. It is expected that these advantages, for example in particular providing reductions in cost and sample volume, will enable a more widespread use of the LD-technique in the field of understanding molecular interactions in e.g. DNA and cell membrane models.

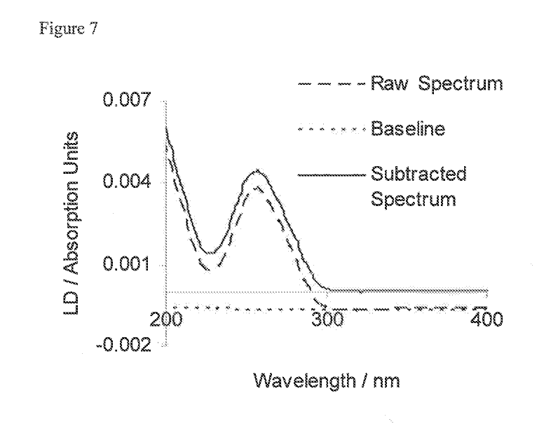

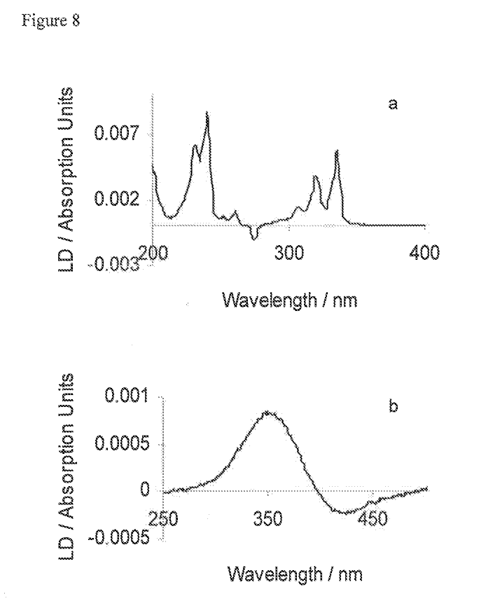

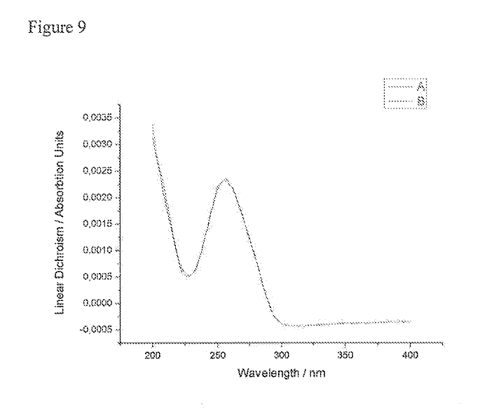

FIG. 7-9 show the results of further experiments, where FIG. 7 shows the LD-absorption spectra of ct-DNA with f=4 Hz and 5 mm amplitude, demonstrating the unaltered spectra and baseline spectra obtained with the design. FIG. 8 shows is a graph that shows the LD of a) Pyrene and b) Retinoic acid in Liposomes, and FIG. 9 is a graph that shows the LD spectra of two successive measurements of the same sample demonstrating the repeatability of the measurements. The two spectra show almost a perfect overlap.

### Example 5

### Orientation Relaxation in the Absence of Flow

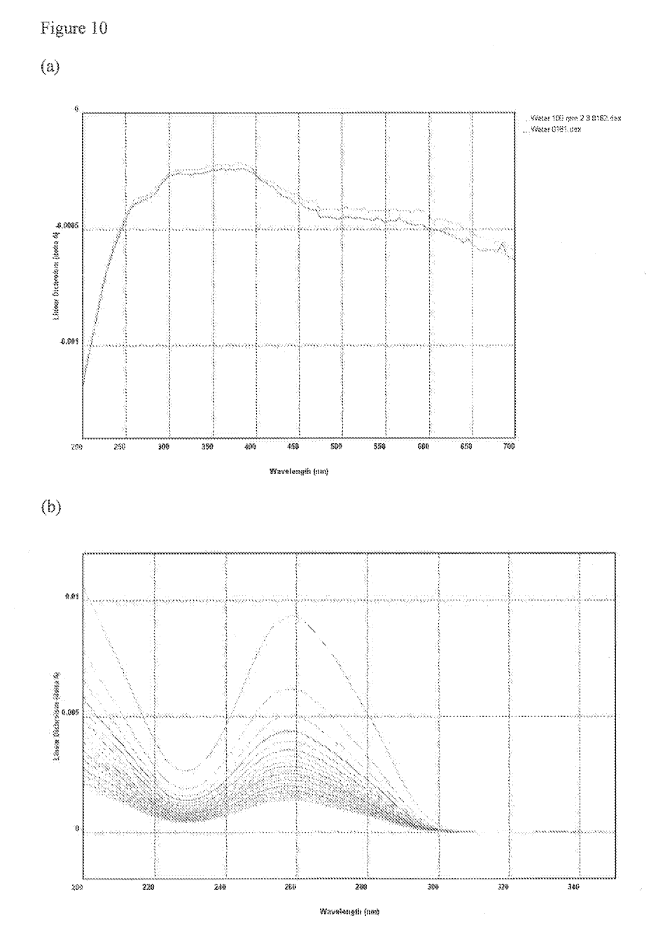

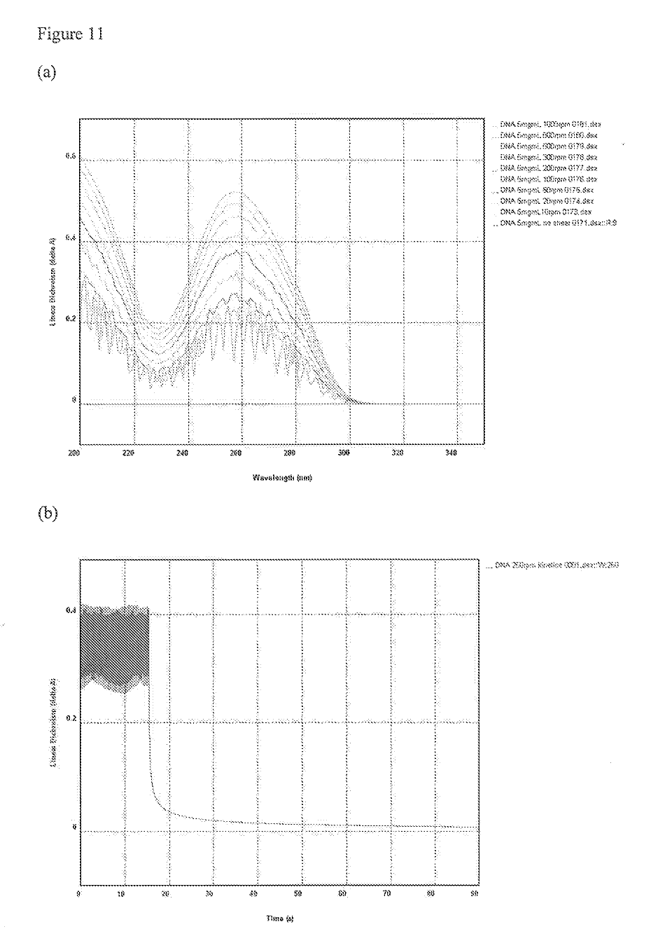

The device of the present invention can also be used for studying orientation relaxation in absence of flow. For example, decay can be studied as a function of time. (see, e.g. FIGS. 10 and 11). In contrast to electric field-induced orientation and relaxation, the flow-orientation relaxation is reflecting a smooth return to random orientation without any harsh disturbances of ionic atmosphere or heating effects due to electric fields. The relaxation curve contains information about the size, shape, contour length and stiffness (persistence length) of the flow-aligned macromolecule. Potential applications include studies of effects of denaturing agents or salt solution (the latter impossible in case of electric orientation due to strong heat dissipation). Changed orientation properties due to the formation of complexes (for example antigen/antibody or other protein complex) may also be a principle of analytical application.

### Materials

The above experiments were carried out with, but not limited to, the following materials.

Calf thymus DNA

Calf thymus DNA was purchased from Sigma-Aldrich. Samples were made up to 0.5 mM in a 0.1 M, pH 7.4 sodium phosphate buffer. Concentrations were determined spectrophotometrically with c=6600 M⁻¹ cm⁻¹.

Large Unilamellar Vesicles (LUVs)

Lipids dissolved in chloroform were mixed in the desired molar ratios and the solvent was evaporated in a rotary evaporator under reduced pressure. Vesicles were prepared by vortexing a dispersion of the lipid film in buffer and subsequently subjecting the suspension to five freeze/thaw cycles (liquid nitrogen/40° C.). Finally the product was extruded 21 times through polycarbonate filters with a pore diameter of 100 nm using a LiposoFast-Pneumatic extruder (Avestin, Canada). Pyrene and retinoic acid were purchased from Sigma Aldrich

Amyloid Fibrils

Bovine insulin and Thioflavin T were used as purchased from Sigma-Aldrich. The fibrils were prepared by heating a 5 mg ml⁻¹ insulin solution in 0.01 M HCl at 60° C. for 18 h. The fibril solution was then centrifuged at 3000 rpm for 3 min. The supernatant was removed and saved for the measurements. Concentrations were determined spectrophotometrically with ε₂₈₀=5840M⁻¹ cm¹. The Thioflavin T (ThT) solution used for staining was prepared by dissolving the ThT in milli-Q water at a concentration of 0.8 mg ml⁻¹. LD solution was prepared by diluting an aliquot of insulin fibrils and an aliquot of ThT stock solution with pH 5 citrate buffer.

### Other Embodiments

From the foregoing description, it will be apparent that variations and modifications may be made to the invention described herein to adopt it to various usages and conditions. Such embodiments are also within the scope of the following claims.

The recitation of a listing of elements in any definition of a variable herein includes definitions of that variable as any single element or combination (or subcombination) of listed elements. The recitation of an embodiment herein includes that embodiment as any single embodiment or in combination with any other embodiments or portions thereof.

All patents and publications mentioned in this specification are herein incorporated by reference to the same extent as if each independent patent and publication was specifically and individually indicated to be incorporated by reference.

### REFERENCES

1. M. F. Hanzal-Bayer and J. F. Hancock, Febs Lett, 2007, 581, 2098-2104.
2. K. Jacobson, O. G. Mouritsen and R. G. W. Anderson, Nat Cell Biol, 2007, 9, 7-14.
3. Y. Landry and J. P. Gies, Fund Clin Pharmacol, 2008, 22, 1-18.
4. B. Norden, A. Rodger and T Dafform, Linear Dichroism and Circular Dichroism. A Textbook on Polarized-Light Spectroscopy. Royal Society of Chemistry, Cambridge 2010.
5. B. Norden, G. Lindblom and I. Jonas, J Phys Chem-Us, 1977, 81, 2086-2093.
6. F. R. Svensson, P. Lincoln, B. Nordèn and E. K. Esbjörner, J Phys Chem B, 2007, 111, 10839-10848.
7. M. Ardhammar, P. Lincoln and B. Norden, P Natl Acad Sci USA, 2002, 99, 15313-15317.
8. P. M. Dolan, D. Miller, R. J. Cogdell, R. R. Birge and H. A. Frank, J Phys Chem B, 2001, 105, 12134-12142.
9. B. Norden, Appl Spectrosc Rev, 1978, 14, 157-248.
10. A. S. Prishchepov and S. G. Prokopenko, J. Appl. Spectrosc, 1999, 66, 311-314.
11. H. Vanamerongen, H. Vasmel and R. Vangrondelle, Biophys J, 1988, 54, 65-76.
12. M. Jonsson, B. Akerman and B. Norden, Biopolymers, 1988, 27, 381-414.
13. R. Svingen, P. Alexandridis and B. Åkerman, Langmuir, 2002, 18, 8616-8619.
14. J. Rajendra, M. Baxendale, L. G. Dit Rap and A. Rodger, J Am Chem Soc, 2004, 126, 11182-11188.
15. A. Wada and S. Kozawa, J Polym Sci Part A, 1964, 2, 853-&.
16. M. Takahashi, M. Kubista and B. Norden, J Biol Chem, 1987, 262, 8109-8111.
17. R. Marrington, T. R. Dafform, D. J. Halsall and A. Rodger, Biophys J, 2004, 87, 2002-2012.
18. C. S. Lee and N. Davidson, Biopolymers, 1968, 6, 531-&.
19. C. Houssier, B. Hardy and Frederic. E, Biopolymers, 1974, 13, 1141-1160.
20. B. Norden, M. Kubista and T. Kurucsev, Q Rev Biophys, 1992, 25, 51-170.
21. C. Dicko, M. R. Hicks, T. R. DAfform, F. Vollrath, A. Rodger and S. V. Hoffman, Biophys. J., 2008, 113, 12090-12095.
22. C. C. Kitts and D. A. V. Bout, J Phys Chem B, 2009, 113, 12090-12095.
23. M. R. H. Krebs, E. H. C. Bromley and A. M. Donald, J Struct Biol, 2005, 149, 30-37.
23. Ardhammar, M., Lincoln, P. and Norden, B. Invisible Liposomes: Refractive Index Matching with Sucrose Enables Flow Dichroism Assessment of Peptide Orientation in Lipid Vesicle Membranes Proc. Natl. Acad. Sci. USA 99 (2002) 15313-15317.
24. Wirth, M., Buchardt, O., Koch, T., Nielsen, P. E. and Nordén, B. Interactions Between DNA and Mono-, Bis-, Tris-, Tetrakis- and Hexakis (aminoacridines). A Linear and Circular Dichroism, Electric Orientation Relaxation, Viscometry, and Equilibrium Study. J. Am. Chem. Soc. 110 (1988) 932-939.
25. Rodger, A. and Nordén, B. Circular dichroism and linear dichroism. (Textbook in spectroscopy with polarized light). Oxford University Press London-New York 1997.
26. Morimatsu, K., Takahashi, M. and Nordén, B. Arrangement of RecA Protein in Its Active Filament Determined by Polarized-Light Spectroscopy Proc. Natl. Acad. Sci. USA 99 (2002) 11688-11693.
27. Reymer A, Frykholm K, Morimatsu K, Takahashi M, Nordén B Structure of human Rad51 protein filament from molecular modeling and site-specific linear dichroism spectroscopy Proc.Nat.Ac.Sci. 106 (2009) 13248-13253.

1. A shear flow device (100) comprising:
a cell (110), wherein the cell is static and comprises at least one stationary plate (110a, 110b); and
a movable slide (130).

2. The shear-flow device of claim 1, comprising two stationary plates (110a, 110b).

3. The shear-flow device of claim 2, wherein the slide (130) fits inside the cell.

4. The shear-flow device of claim 1, wherein the plates (110a, 110b) are separated by a spacer.

5. (canceled)

6. (canceled)

7. The shear-flow device of claim 1, wherein the plates are quartz.

8. (canceled)

9. The shear flow device of claim 1, further comprising a plurality of rods (160).

10. (canceled)

11. (canceled)

12. The shear flow device of claim 9, wherein the slide is fastened onto a block (150) that is guided by the rods.

13. (canceled)

14. The shear-flow device of claim 1, wherein the slide is connected to a lever, and wherein the lever is connected to a motor via an eccentric wheel.

15. The shear-flow device of claim 1, wherein the quartz slide (130) is moved in an oscillating motion.

16. The shear-flow device of claim 1, wherein an LD spectrum is recorded during oscillation and a baseline is recorded at rest.

17. The shear-flow device of claim 1, wherein an absorbance spectrum (A) is recorded at rest.

18. The shear-flow device of claim 1, wherein the device is used for the orientation of molecules for Linear Dichroism (LD) measurement.

19. A method of orienting molecules for LD measurement comprising:
applying a liquid sample to the device of claim 1, wherein the liquid sample is subject to an oscillating flow, thereby orienting the molecules for LD measurement.

20. The method of claim 19, wherein LD is measured according to Formula 1:
LD=A₍ₚₐᵣₐₗₗₑₗ₎−A_{(perpendicular)} (Formula 1)
wherein A is the absorption of the oriented molecules parallel and perpendicular to flow lines.

21. The method of claim 19, wherein the liquid sample volume is between 0.2 nanoliter−1.0 ml.

22. The method of claim 19, further comprising determining a quotient spectrum according to Formula 2
LD/A (Formula 2)
wherein the quotient spectrum provides information about DNA orientation or DNA structure.

23. A method for creating an oriented macromolecule or macromolecule complex comprising:
applying a liquid sample comprising the macromolecule or test sample to the device of claim 1, wherein the liquid sample is subject to an oscillating flow.

24. The method of claim 23, wherein the macromolecule is selected from DNA, RNA or protein.

25. The method of claim 23, wherein the test sample comprises an agent.

26. The method of claim 25, wherein the agent is a pharmaceutical.

27. (canceled)
